(19) United States
(12) Patent Application Publication
(10) Pub. No.: US 2019/0196226 A1
(43) Pub. Date: Jun. 27, 2019

(54) WEARABLE HEADS-UP DISPLAYS EMPLOYING A CORE WIRE COMMUNICATIVELY COUPLED TO A RADIO AS AN ANTENNA

(71) Applicant: NORTH INC., Kitchener (CA)

(72) Inventors: Joshua Moore, Elora (CA); Kai Zhang, Waterloo (CA); George Shaker, Waterloo (CA)

(21) Appl. No.: 16/231,270

(22) Filed: Dec. 21, 2018

Related U.S. Application Data
(60) Provisional application No. 62/609,607, filed on Dec. 22, 2017.
(60) Provisional application No. 62/695,591, filed on Jul. 9, 2018.

(51) Int. Cl. G02C 11/00; G02B 27/01; G02C 13/00; G02C 3/00; G02C 5/22; H04B 7/04; H01Q 1/27

(52) U.S. Cl. CPC G02C 11/10; G02B 27/017; G02C 13/001; G02B 2027/0178; G02C 5/22; H04B 7/04; H01Q 1/273; G02C 3/003

(57) ABSTRACT

Systems, devices and methods for eyeglasses frames and eyeglasses frames assemblies for wearable electronic devices, and particularly systems, devices, and methods that employ an antenna in eyeglasses frames and eyeglasses frames assemblies for wearable heads-up displays, the systems, devices and methods including a pair of eyeglasses having a first arm housing a radio and a core wire, wherein the core wire is communicatively coupled to the radio as an antenna by an electrically conductive path including a hinge in the first arm or an electrically conductive path that is electrically isolated from the hinge and a power source coupled to the first arm or a second arm and electrically coupled to the radio via a second electrically conductive path.

### TECHNICAL FIELD

The present systems, devices, and methods generally relate to eyeglasses frames and eyeglasses frames assemblies (i.e., eyewear) for wearable electronic devices, and particularly relate to systems, devices, and methods that employ a core wire as an antenna in eyeglasses frames and eyeglasses frames assemblies for wearable heads-up displays.

### BACKGROUND

### Description of the Related Art

### Wearable Heads-Up Displays

A head-mounted display is an electronic device that is worn on a user's head and, when so worn, secures at least one electronic display within a viewable field of at least one of the user's eyes, regardless of the position or orientation of the user's head. A wearable heads-up display is a head-mounted display that enables the user to see displayed content but also does not prevent the user from being able to see their external environment. Examples of wearable heads-up displays include: the Google Glass®, the Optinvent Ora®, the Epson Moverio®, and the Microsoft Hololens® just to name a few.

The optical performance of a wearable heads-up display is an important factor in its design. When it comes to face-worn devices, however, users also care a lot about aesthetics. This is clearly highlighted by the immensity of the eyeglass (including sunglass) frame industry. Independent of their performance limitations, many of the aforementioned examples of wearable heads-up displays have struggled to find traction in consumer markets because, at least in part, they lack fashion appeal. Most wearable heads-up displays presented to date are bulky, to enable adequate display performance, and, as a result, appear very unnatural on a user's face compared to the sleeker and more streamlined look of typical eyeglass and sunglass lenses. However, a traditional eyeglasses frame is problematic when correct alignment of optical components carried by the eyeglasses frame is a necessity for a high-quality display. Because traditional eyeglasses have hinges where the arms meet the rest of the frame, any optical components carried on the arms may move relative to the rest of the frame or to the eye of the user while being worn, resulting in loss of or distortion of the display. There is a need in the art for means to successfully integrate electronic components into smaller frames in order to achieve the inconspicuous form factor and fashion appeal expected of the eyeglass frame industry while still maintaining a high display quality.

### Inter-Device Connectivity

Another important factor in the design of electronic devices, including wearable heads-up displays, is the integration of components that allow for communication between devices. Examples of systems that integrate such inter-device connectivity are smart phones, watches, and headphones with Bluetooth® radio antennas. However, the design form factor and location of an antenna within an electronic device is important because the location of the antenna relative to other components, both electronic and non-electronic, within the device impacts the functionality of the antenna. In some cases, interference from other components within the device significantly reduces the range, signal strength, and overall connectivity capabilities of the antenna, thus preventing the antenna from effectively connecting or communicating with other electronic devices. In many cases, a similar result occurs depending on the distance and orientation of the antenna relative to an external device with which the antenna is communicating. As such, there remains a need in the art for integrating radio antennas into a compact, aesthetically-pleasing form factor for a wearable heads-up display in order to maximize connectivity, range, and signal strength of the antenna, regardless of the position of an external device relative to the antenna over a given range.

### BRIEF SUMMARY

A first exemplary implementation of an apparatus, such as a glasses form factor for a wearable heads-up display, may be summarized as including: a front eyeglass frame, including: a first rim, a second rim, and a bridge that physically couples the first rim and the second rim; a first arm coupled to the first rim and having a first temple portion including an anterior portion and a posterior portion; a second arm coupled to the second rim and having a second temple portion; a radio operable to at least one of receive or transmit wireless signals; and a core wire housed in the first arm and that extends along at least a portion of the posterior portion of the first temple portion, the core wire repeatedly plastically deformable without breaking to retain at least the posterior portion in a shape, the core wire communicatively coupled to the radio as an antenna.

The apparatus may further include: the radio being operable to at least one of receive or transmit wireless signals at a first wavelength, and the core wire having a length that is at least approximately equal to a reciprocal of an integer of the wavelength; the radio being operable to at least one of receive or transmit wireless signals at a first wavelength, and the core wire having a length that is at least approximately equal to ¼, ⅓, or ½ of the wavelength; a length of the antenna being between 30 millimeters and 63 millimeters; at least a piece of the posterior portion being metal and coupled to a ground; a hinge between the anterior portion and the posterior portion and a printed circuit board in electrical communication with the core wire; and the core wire being electrically coupled to the hinge and extending from the hinge along at least the portion of the posterior portion of the first temple portion.

The apparatus may further include: an electrically conductive path from the printed circuit board to the core wire passing through at least the portion of the posterior portion, a portion of the hinge, and a portion of the anterior portion of the first temple portion; the electrically conductive path including: the printed circuit board housed in the anterior portion, the radio carried by the printed circuit board, the hinge, a conduit electrically connecting the hinge and the printed circuit board, and the core wire electrically coupled to the hinge; the conduit being one of a coaxial cable electrically coupled between the printed circuit board and the hinge and a shielded trace carried by at least one layer of the printed circuit board; an electrically conductive path between the printed circuit board and the core wire passing through at least the portion of the posterior portion and a portion of the anterior portion of the first temple portion, wherein the hinge is electrically isolated from the electrically conductive path.

The apparatus may further include: the electrically conductive path including: a first contact in the anterior portion proximate the hinge, a conduit electrically connecting the printed circuit board to the first contact, a second contact in the posterior portion proximate the hinge, the second contact electrically coupled to the core wire, and a pin having an unfolded configuration and a folded configuration, wherein in the unfolded configuration, the pin electrically couples the first contact and the second contact and in the folded configuration, the pin isolates the first contact from the second contact; the conduit being one of a coaxial cable and a shielded trace; the pin comprising a first pin portion and a second pin portion, the first pin portion electrically coupled to the core wire and the second pin portion electrically coupled to the first pin portion, the second pin portion removably coupleable with the first contact; and a housing surrounding at least the second pin portion, the housing received by the anterior portion of the first temple portion.

The core wire may be deformable without breaking to retain at least the posterior portion in a shape.

A second exemplary implementation of an apparatus, such as a glasses form factor for a wearable heads-up display, may be summarized as including: a front eyeglass frame, including: a first rim, a second rim, and a bridge that physically couples the first rim and the second rim; a first arm coupled to the first rim and having a first temple portion, the first temple portion including an anterior portion, a posterior portion, and a first hinge between the anterior portion and the posterior portion of the first arm; a second arm coupled to the second rim and having a second temple portion, the second temple portion including a second hinge; a radio operable to at least one of receive or transmit wireless signals; a core wire housed in the first arm and extending along at least a portion of the posterior portion of the first temple portion, the core wire communicatively coupled to the radio as an antenna; and an electrically conductive path electrically connecting the radio and the core wire, the electrically conductive path passing through the first hinge, wherein the first hinge is electrically isolated from the electrically conductive path.

The apparatus may further include: the electrically conductive path including a conduit, the conduit comprising one of a flexible coaxial cable and a flexible shielded trace; the core wire being repeatedly plastically deformable without breaking to retain at least the posterior portion in a shape; and the first hinge being plastic.

The radio may be operable to at least one of receive or transmit wireless signals at a first wavelength, and the core wire may have a length that is at least approximately equal to a reciprocal of an integer of the wavelength. For example, the core wire may have a length that is at least approximately equal to ¼, ⅓, or ½ of the wavelength. The length of the antenna may be between 30 millimeters and 63 millimeters.

At least a piece of the posterior portion may be metal, and may be coupled to a ground.

A third exemplary implementation of an apparatus, such as a glasses form factor for a wearable heads-up display, may be summarized as including: a front eyeglass frame, including: a first rim, a second rim, and a bridge that physically couples the first rim and the second rim; a first arm coupled to the first rim and having a first temple portion, the first temple portion including an anterior portion, a posterior portion, and a first hinge between the anterior portion and the posterior portion of the first arm; a second arm coupled to the second rim and having a second temple portion, the second temple portion including a second hinge; a radio operable to at least one of receive or transmit wireless signals; a core wire housed in the first arm and that extends along at least a portion of the posterior portion of the first temple portion, the core wire communicatively coupled to the radio as an antenna; and an electrically conductive path electrically connecting the radio and the core wire, the electrically conductive path including at least a portion of the first hinge.

The apparatus may further include: the first hinge comprising a barrel hinge, the barrel hinge including at least a first barrel coupled to a second barrel by a fastener, wherein the electrically conductive path includes at least a portion of the first barrel and a portion of the second barrel; the first hinge comprising a spring hinge, the spring hinge including at least a first barrel coupled to a second barrel by a fastener and a spring coupled to the first barrel and the second barrel, wherein the electrically conductive path includes at least a portion of the first barrel, a portion of the second barrel, and the spring; the first hinge further including: an outer housing, an inner housing coupled to the outer housing by a first fastener, the inner housing having a first barrel, a spring housed in the inner housing and coupled to the first barrel, and a second barrel coupled to the first barrel and the inner housing by a second fastener; the electrically conductive path including the first fastener, the outer housing, the second fastener, and the second barrel; and the electrically conductive path including the first fastener, the first barrel, and the second barrel.

The radio may be operable to at least one of receive or transmit wireless signals at a first wavelength, and the core wire may have a length that is at least approximately equal to a reciprocal of an integer of the wavelength. For example, the core wire may have a length that is at least approximately equal to ¼, ⅓, or ½ of the wavelength. The length of the antenna may be between 30 millimeters and 63 millimeters.

At least a piece of the posterior portion may be metal, and may be coupled to a ground. The core wire may be deformable without breaking to retain at least the posterior portion in a shape.

A wearable heads-up display (“WHUD”) according to some of the teachings herein may be summarized as including a support structure that in use is worn on a head of a user and a display component carried by the support structure. The display component allows the user to view displayed content (i.e., on a transparent combiner) but which also permits the user to see their external environment.

In some cases a transparent combiner is positioned within a field of view of an eye of the user when the support structure is worn on the head of the user.

In some implementations the WHUD includes a laser projector carried by the support structure, the laser projector being is positioned and oriented to scan laser light over at least a first area of the transparent combiner. The support structure may have the shape and appearance of an eyeglasses frame and the transparent combiner may include an eyeglass lens.

Generally WHUD also includes a communication module for communication with other electronic devices. In some implementations, the communication module includes an antenna that is at least partially integrated with the support structure. In some implementations, one or more components of the antenna are integrated within one or more of the support arms of a pair of eyeglasses. In some implementations, one or more components of the antenna are integrated within a rim portion of a pair of eyeglasses, the rim portion supporting one or more eyeglass lenses.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements, and may have been solely selected for ease of recognition in the drawings.

FIG. 1 is a perspective view of an exemplary implementation of a glasses frame formed according to the present disclosure.

FIG. 2 is a perspective view of an exemplary implementation of a first arm of a glasses frame according to the present disclosure having an antenna housed in the first arm.

FIG. 3 is a perspective view of an alternative exemplary implementation of a glasses frame formed according to the present disclosure and having an antenna housed in the frame.

FIG. 4A is a left side view of an exemplary implementation of a core wire formed according to the present disclosure and acting as an antenna as part of an electrically conductive path including at least a portion of a hinge.

FIG. 4B is a right side view of the core wire and electrically conductive path of FIG. 4A.

FIG. 4C is a cross-sectional view of the hinge and a portion of the electrically conductive path of FIG. 4A.

FIG. 5A is a right side view of an alternative exemplary implementation of a core wire formed according to the present disclosure and acting as an antenna as part of an electrically conductive path that is electrically isolated from a hinge.

FIG. 5B is a cross-sectional view of a portion of the electrically conductive path of FIG. 5A showing a pin connection in the electrically conductive path.

FIG. 6 is a schematic diagram of a system incorporating a wearable heads-up display in communication with at least one other electronic device in accordance with the present systems, devices, and methods.

FIG. 7 is a schematic diagram of a wearable heads-up display in accordance with the present systems, devices, and methods.

FIG. 8A is a schematic representation of a wearable heads-up display worn on a head of a user.

FIG. 8B is a schematic representation of the wearable heads-up display of FIG. 8A showing an exemplary EM pattern generated by an antenna in the wearable heads-up display.

FIG. 9 is a schematic diagram of a communication module integrated within a support arm of a wearable heads-up display according to the present systems, devices, and methods.

FIG. 10 is a schematic diagram of a communication module having an antenna integrated within a support arm of a wearable heads-up display according to the present systems, devices, and methods.

FIG. 11 is a schematic diagram of a communication module having an antenna integrated within a support arm of a wearable heads-up display according to the present systems, devices, and methods.

FIG. 12 is a schematic diagram of a communication module having an antenna integrated within a support arm of a wearable heads-up display according to the present systems, devices, and methods.

FIG. 13 is a schematic diagram of a communication module having an antenna integrated within a rim portion of a wearable heads-up display according to the present systems, devices, and methods.

FIG. 14 is a schematic diagram of a communication module having an antenna integrated within a rim portion of a wearable heads-up display according to the present systems, devices, and methods.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with antennas, displays, portable electronic devices and head-worn devices have not been shown or described in detail to avoid unnecessarily obscuring descriptions of the implementations.

Unless the context requires otherwise, throughout the specification and claims which follow, the word “comprise” and variations thereof, such as “comprises” and “comprising,” are to be construed in an open, inclusive sense, that is as “including, but not limited to.”

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

Throughout this specification and the appended claims, the term “carries” and variants such as “carried by” are generally used to refer to a physical coupling between two objects. The physical coupling may be direct physical coupling (i.e., with direct physical contact between the two objects) or indirect physical coupling mediated by one or more additional objects. Thus the term “carries” and variants such as “carried by” are meant to generally encompass all manner of direct and indirect physical coupling.

The headings and Abstract of the Disclosure provided herein are for convenience only and do not interpret the scope or meaning of the implementations.

The various implementations described herein provide systems, devices, and methods for eyeglasses frames and eyeglasses frames assemblies for wearable electronic devices, such as a wearable heads-up display, carrying a core wire communicatively coupled to a radio as an antenna for inter-device connectivity. Such glasses include a minimal form factor that is aesthetically pleasing, and an antenna design that enables superior range, signal strength, and overall connectivity capabilities of the antenna.

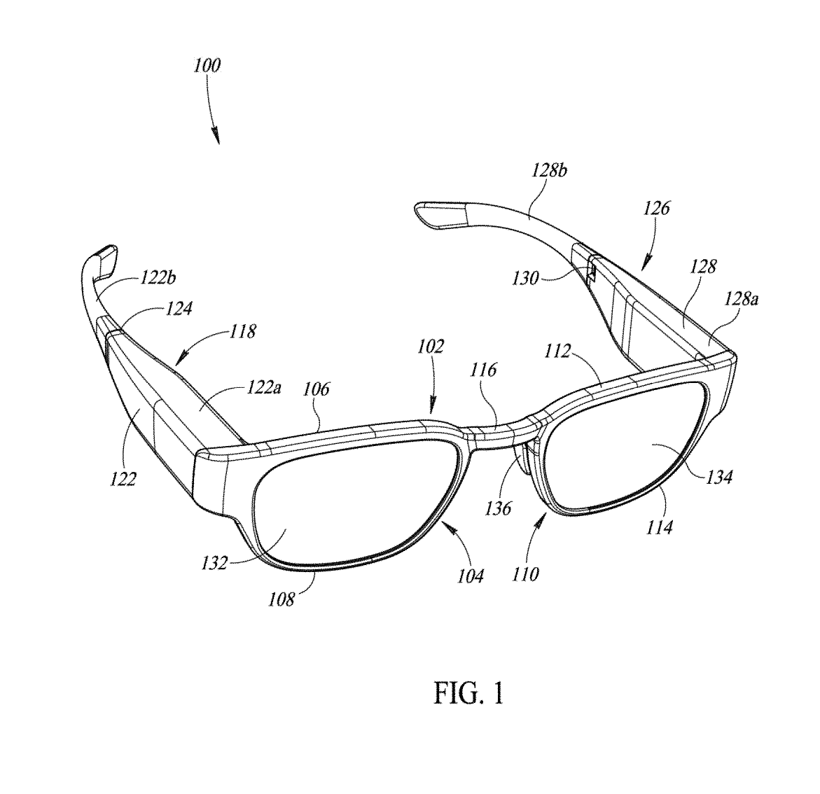

FIG. 1 illustrates an exemplary implementation of eyewear in the form of a pair of eyeglasses 100 having a first arm 118, a second arm 126 and a front eyeglass frame 102 formed in accordance with the present disclosure. The front eyeglass frame 102 includes a first rim 104 having a first upper peripheral portion 106 and a first lower peripheral portion 108. The front eyeglass frame 102 further includes a second rim 110 having a second upper peripheral portion 112 and a second lower peripheral portion 114, and a bridge 116 securely physically coupling the first rim 104 and the second rim 110. In an implementation, the bridge 116 is coupled to the first rim 104 and the second rim 110 between the first upper peripheral portion 106 and the second upper peripheral portion 112. In addition, the front eyeglass frame 102 may be formed as a single, unitary, integral piece or as separate components fastened together with one or more adhesives, screws, or other fasteners.

Eyeglasses 100 also include the first arm 118 coupled to the first rim 104 and having a first temple portion 122. Temple portion 122 is preferably hollow, in order to house certain components as described herein. In an implementation, first arm 118 is stiff and inflexible such that when first arm 118 is coupled to the front eyeglass frame 102, first arm 118 maintains a fixed position relative to the front eyeglass frame 102. In the illustrated implementation, there is no hinge connecting the first arm 118 of the eyeglasses 100 to the front eyeglasses frame 102, in contrast to traditional eyeglasses, although one of skill in the art will appreciate that other implementations include such a hinge.

Further, in an implementation, the first temple portion 122 has a first hinge 124 which separates first temple portion 122 into a first anterior part 122a and a first posterior part 122b, wherein first posterior part 122b folds in towards the front eyeglasses frame 102. In other words, the first hinge 124 is coupled between the first anterior part 122a and the first posterior part 122b such that the first posterior part 122b is rotatable relative to the first anterior part 122a and the front eyeglass frame 102 about the first hinge 124 along at least one axis of rotation passing through the first hinge 124. In an implementation, the first hinge 130 is one of a spring hinge or a barrel hinge.

The pair of eyeglasses 100 includes a second arm 126 coupled to the second rim 110 having a second temple portion 128. Second temple portion 128 is hollow. In an implementation, second arm 126 is stiff and inflexible such that when second arm 126 is coupled to the front eyeglass frame 102, second arm 126 maintains a fixed position relative to the front eyeglass frame 102. There is no hinge connecting the second arm 126 of the eyeglasses 100 to the front eyeglasses frame 102, in contrast to traditional eyeglasses.

In an implementation, second temple portion 128 has a second hinge 130 which separates second temple portion 128 into a second anterior part 128a and a second posterior part 128b, wherein second posterior part 128b folds in towards the front eyeglasses frame 102. In other words, the second hinge 130 is coupled between the second anterior part 128a and the second posterior part 128b such that the second posterior part 128b is rotatable relative to the second anterior part 128a and the front eyeglass frame 102 about the second hinge 130 along at least one axis of rotation passing through the second hinge 130. In an implementation, the second hinge 130 is one of a spring hinge or a barrel hinge.

Temple portions 122 and 128 each preferably sit on, and extend beyond, a respective ear of a user to hold eyeglasses 100 on a head of the user. The front eyeglass frame 102 further includes a first lens 132 mounted in the first rim 104 and a second lens 134 mounted in the second rim 110. As such, front eyeglass frame 102 has the shape and appearance of a front of a traditional pair of eyeglasses. Lenses 132 and 134 may be inserted and held in respective rims 104 and 110 by an interference fit, friction fit, press fit, or by a heat/shrink fit. Each of rims 104 and 110 is of a size and shape that can receive the respective lens 132 and 134 and hold the lenses 132 and 134 in place without any movement once the lenses 132 and 134 are inserted. Assembly of the eyeglasses 100 may include the technology described in U.S. Provisional Patent Application Ser. No. 62/609,607 and U.S. Provisional Patent Application Ser. No. 62/634,654.

In an implementation, eyeglasses 100 are a wearable heads-up display wherein display-producing components are present within or carried by one or both arms 118 and 126 (i.e., one arm for a monocular display, both arms for a binocular display) and display components are embedded within or carried by one or both lenses 132 and 134. In addition, as described in more detail below, the eyeglasses 100 may include an antenna (not shown) and a power source (not shown) in addition to power circuitry (e.g., processor, radio (e.g., transmitter, receiver or transceiver coupled to one or more antenna)) in order to provide inter-device connectivity between the eyeglasses 100 and external electronic devices, such as a smart phone (not shown) or a ring worn on the user's finger that implements the technology described in U.S. Provisional Patent Application Ser. No. 62/236,060, U.S. Non-Provisional patent application Ser. No. 15/282,535 (now US Patent Application Publication 2017/0097753), and U.S. Non-Provisional patent application Ser. No. 15/799,642 (now US Patent Application Publication 2018/0067621).

In an implementation, the arms 118 and 126 carry certain display-producing components, for example one or more of a projector (e.g., a scanning laser projector with laser diodes), or a micro-display (e.g., liquid crystal display (LCD) or organic light emitting diode (OLED) display). The display components embedded in the lenses 132 and 134 may be a waveguide which receives light from the display-producing components and guides the light towards an eye of the user, or may be a reflector, refractor, or diffractor; for example, a holographic optical element, to, for example, provide an augmented reality experience. The fixed position of at least the anterior portions 122a and 128a of the arms 118 and 126 relative to the front eyeglasses frame 102 may enable correct initial and “in-use” positioning of components such as the projector and holographic optical element, in implementations where such components are used.

Further, the eyeglasses 100 may include adjustable nose pads, such as nose pad 136, to assist with customization of the fit of eyeglasses 100 to the user. The eyeglasses 100 preferably include two nose pads 136, wherein each nose pad 136 is coupled to a respective rim 104, 110, and the nose pads 136 are adjustable in orientation as well as vertically and horizontally. Accordingly, the nose pads 136 enable lenses 132, 134 to be adjusted relative to the user's eye (i.e., adjusting the nose pads 136 adjusts a height of the lenses 132, 134 relative to the eyes of a user), which one of skill in the art will appreciate is an important design consideration for wearable heads-up displays including display components. Adjusting the angular orientation of the nose pads 136 enables a secure fit on the user's nose to further prevent the eyeglasses 100 from falling off of a user's face. In an implementation, nose pads 136 are also adjustable horizontally so as to further assist in adjusting the eyeglasses 100 with respect to the eye of a user, and further enabling a secure fit on the nose of the user (i.e., adjusting width ensures the nose pads 136 establish a secure, comfortable fit with a nose of a user, and adjusting positioning of nose pads 136 with respect to front eyeglass frame 102 enables positioning with respect to eyes of the user).

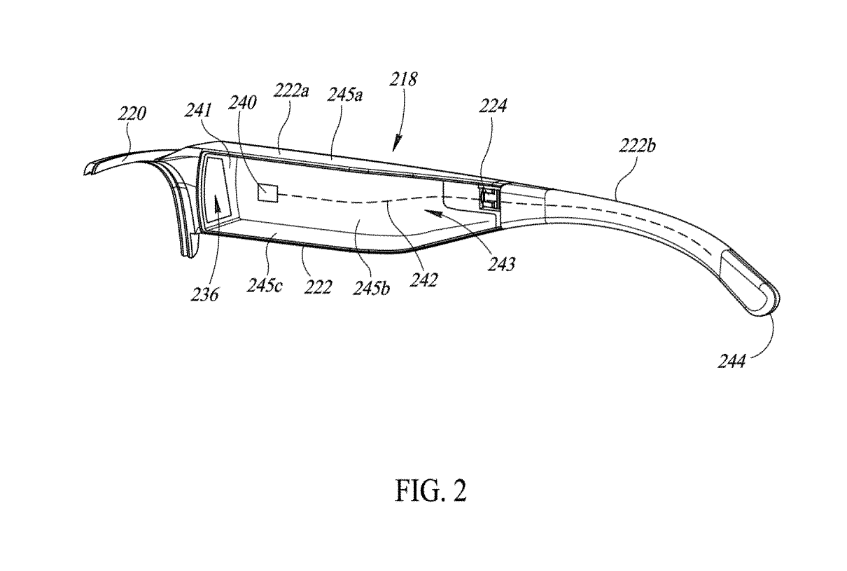

Referring now to FIG. 2 with continuing reference to FIG. 1, such “in-use” positioning may be further enabled by a core wire, illustrated in FIG. 2 by dashed line 242. The core wire 242 is located in at least one of, or preferably both of, the first arm 118 and the second arm 126, wherein the core wire 242 is repeatedly plastically deformable to retain a portion of the first arm 118 or second arm 126 in a shape provided by the user. Preferably, the core wire 242 is housed in, and extends along, at least a portion of the first posterior part 122b or the second posterior part 128b. In various implementations, at least the portion of the first posterior part 122b or the second posterior part 128b includes less than half, at least half, at least three quarters, or substantially all of the first posterior part 122a or the second posterior part 128b, wherein the first posterior part 122b and the second posterior part 128b are formed of an elastic or semi-elastic material, such that the core wire 242 can be used to adjust the eyeglasses 100 to the head of the user. The core wire 242 preferably comprises a repeatedly plastically deformable material, which may include a metal or metal alloy, for example stainless steel, titanium, beta titanium (i.e., titanium alloy including vanadium and aluminum), a titanium nickel alloy, beryllium, or a nickel and copper alloy, or various combinations thereof, among others. The repeatedly plastically deformable material may also include certain thermoplastics, for example acrylic, acrylonitrile butadiene styrene, nylon, polylactic acid, polybenzimidazole, polycarbonate, polyether sulfone, polyoxymethylene, polyetherether ketone, polyetherimide, polyethylene, polyphenylene oxide, polyphenylene sulfide, polypropylene, polystyrene, polyvinyl chloride, Teflon, or combinations thereof, among others. However, one of skill in the art will appreciate that other materials may be available that are repeatedly plastically deformable. In some instances, at least a portion of the eyeglasses 100 may be warmed before or as part of shaping the first and second arms 118, 126, and more specifically, at least the first and second posterior parts 122b, 128b may be warmed.

FIG. 2 further illustrates a perspective view of an exemplary implementation of a first arm 218 of a pair of eyewear, such as eyeglasses 100. One of skill in the art will appreciate that the first arm 218 can be substantially similar to first arm 118 or second arm 126 in FIG. 1. Accordingly, the features described with reference to first arm 218 may be incorporated into implementations of first arm 118 or second arm 126, or both, in eyeglasses 100, as well as in other implementations disclosed herein.

First arm 218 includes a first frame portion 220 and a first temple portion 222. Temple portion 222 is preferably hollow to receive components for a wearable heads-up display within the eyewear, for example eyeglasses 100, as described herein. The temple portion 222 preferably has a first aperture 236 at a front thereof, which may also assist with placing the components, or alternatively, may receive an antenna. First frame portion 220 is preferably stiff and inflexible such that when first frame portion 220 is coupled to the front eyeglass frame 102, first arm 218 maintains a fixed position relative to the front eyeglass frame 102. First frame portion 220 and first temple portion 222 may be formed as a single, unitary, integral component, or may be two components which are combined to make first arm 218. In the implementation illustrated in FIG. 2, first frame portion 220 is attached to first temple portion 222 with screws, but one of skill in the art will appreciate that other fasteners may be used (e.g., bolts, rivets, adhesive, epoxy, etc.).

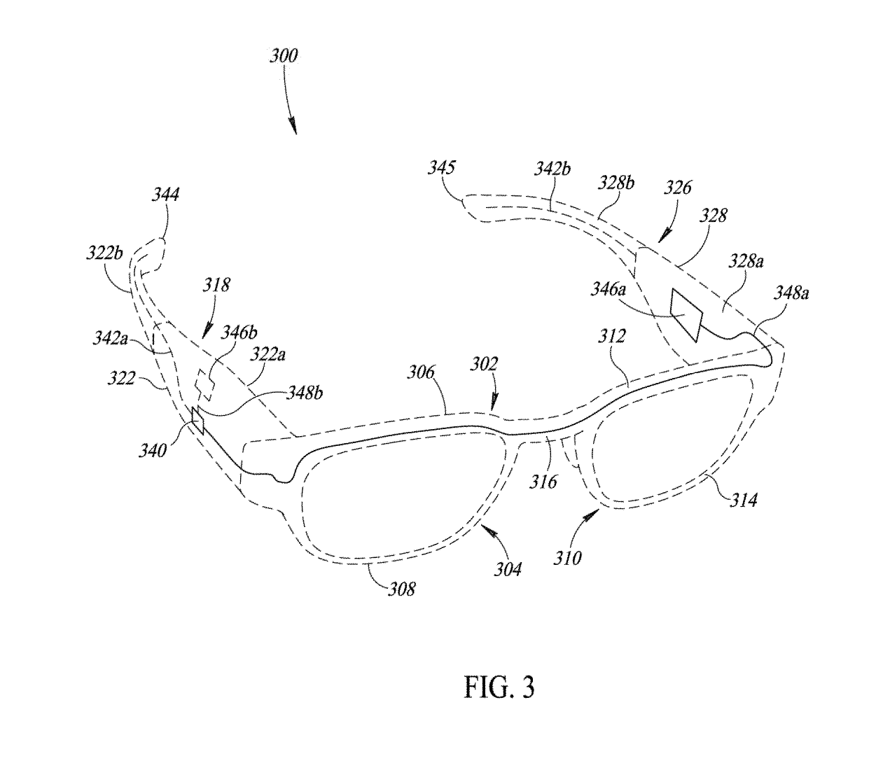

First arm 218 further includes a first hinge 224, which separates the first temple portion 222 into a first anterior part 222a and a first posterior part 222b. The first hinge 224 is preferably one of a barrel hinge or a spring hinge, as described in greater detail herein. However, in some implementations, the first arm 218 does not include the first hinge 224, in which case the anterior and posterior parts 222a and 222b are simply anterior and posterior portions of the temple portion 222. Further, the first anterior part 222a of the first temple portion 222 of the first arm 218 includes a front end 241 proximate the first frame portion 220. In an assembled eyeglass frame, such as eyeglasses 100, 300 described herein, the front end 241 is also proximate the front eyeglass frame (not shown), which may be substantially similar to front eyeglass frame 102, 302 in FIGS. 1 and 3, respectively. In an implementation, the first aperture 236 is formed in the front end 241.

In FIG. 2, a radio 240 is housed within the first arm 218, and preferably within the first temple portion 222, and even more preferably within the first anterior part 222a of the first temple portion 222. In some implementations, the radio 240 may be coupled to a printed circuit board (not shown) housed in the first temple portion 222, in which case, the radio 240 is in electrical communication with electrically conductive traces of the printed circuit board (not shown). In an implementation, the radio 240 can take the form of a transmitter and, or, a receiver or a transceiver. In the illustrated implementation, core wire 242 is communicatively coupled to the radio 240 as an antenna.

In other words, the radio 240 is operable to at least one of receive or transmit wireless signals at a wavelength, and the core wire 242 comprises an electrically conductive material, which includes the various repeatedly plastically deformable metals described herein, and has a length that is at least approximately equal to a reciprocal of an integer of the wavelength of the signals. For example, the length of the core wire 242 may be approximately equal to ¼, ⅓, or ½ of the wavelength of the wireless signals transmitted by, or received by, the radio 240. In this context, “approximately” means within +/−3 millimeters (i.e., if ¼ of the wavelength of the signal is 32 millimeters, a length of the core wire 242 that is approximately equal to ¼ wavelength of the signal corresponds to the length of the core wire 242 being between 29 millimeters and 35 millimeters). In an implementation, the length of the core wire 242 is between 30 millimeters and 63 millimeters, which corresponds to between approximately ¼ and ½ of the wavelength of a signal in the 2.4 GHz range. The radio 240 and core wire 242 are operable to provide wireless communications in the radio frequency and, or, microwave frequency bands of the electromagnetic spectrum.

While the core wire 242 is illustrated in FIG. 2 as a dashed line, one of skill in the relevant art will appreciate that the antenna 242 can be a variety of geometric shapes with varying cross sections. For example, in various implementations, the core wire 242 has a circular, ovular, triangular, rectangular, or square cross section along its length. In addition, in certain other implementations, the core wire 242 changes size along its length, for example, a dimension between outer surfaces of the core wire 242 proximate the radio 240 may be greater than, equal to, or less than, a dimension between outer surfaces of the core wire 242 proximate a first distal end 244. Still further, the core wire 242 can change size and or shape along its length, such that in an implementation, the core wire 242 is continuously tapered along at least a portion of its length or all of its length, while in other implementations, a greatest dimension between exterior surfaces of the core wire 242 along its length changes multiple times, such as in a “step-down” configuration. Still further, the antenna 242 can include different cross sections along its length along with one or more transitions, for example, a portion of the core wire 242 proximate the radio 240 may have a circular or square cross section, a portion of the core wire 242 proximate its mid-point may have a triangular cross section, and a portion of the core wire 242 proximate the first distal end 244 may have a circular cross section. There may also be one or more gaps or apertures along the length of the core wire 242. Accordingly, implementations of the present disclosure encompass a wide variety of shapes and configurations of the core wire 242.

In still further implementations, the first anterior part 222a of the first arm 218 includes a U-shaped cross section along at least a portion of its length, wherein the first anterior part 222a comprises a metal. In other words, the first anterior part 222a is a channel 243 including sidewalls 245a, 245b, and 245c such that the cross section of the channel 243 is generally in the shape of a “U,” wherein at least one of the sidewalls 245a, 245b, and 245c, or, more preferably, all of the sidewalls 245a, 245b, and 245c comprise metal along at least a portion of the length of the sidewalls 245a, 245b, and 245c. The sidewalls 245a, 245b, and 245c may also optionally include a metal portion for heat dissipation surrounded by plastic or non-metallic portions in the remainder of the first anterior part 222a. As such, in an implementation, the U-shaped cross section is metal. In other implementations, only a portion of the first anterior part 222a is metal (i.e., one of the sidewalls 245a, 245b, and 245c is metal and the remaining sidewalls are plastic or a non-metallic material), while in further implementations, the entire U-shaped cross section is plastic or other non-metallic material. The front end 241 may be metal, plastic, or other non-metallic material.

In implementations where at least a portion of the first anterior part 222a comprises metal or a material with high thermal conductivity, electronic components that may be present in the first anterior part 222a may be thermally conductively coupled to the sidewalls 245a, 245b, and 245c with a thermally conductive fastener. One of skill in the art will recognize that, because the sidewalls 245a, 245b, and 245c of the first anterior part 222a have a comparatively large surface area (i.e., relative to individual electronic components) that is exposed to the external environment, the metal of the sidewalls 245a, 245b, and 245c of the first anterior part 222a in such implementations dissipates heat produced during operation of the electronic components in an effective manner. As such, it is preferable that the adhesive, fasteners, or other securing means used to couple the radio 240 and other components to the first anterior part 222a allow for heat transfer. Examples of adhesives that enable such heat transfer include, but are not limited to, adhesives, epoxies, glues or polymers entrained with various proportions of metals.

Further, the first posterior part 222b may be metal along at least a portion of its length. In an implementation, the entire first posterior part 222b is metal, while in other implementations, at least a piece of the first posterior part 222b comprises metal. In such an implementation, the metal piece of the first posterior part 222b, or the entire first posterior part 222b, can be coupled to a ground, so as to electrically isolate the first posterior part 222b from the core wire 242, which may be communicatively coupled to the radio 240 as a radio, wherein the grounding reduces interference between the core wire 242 and the first posterior part 222b. In other implementations, the first posterior part 222b is plastic, or other flexible or deformable materials, such as various thermoplastic polymers.

In an alternative implementation, the core wire 242 is electrically coupled to a conduit (included as part of dashed line 242) that passes through the first hinge 224. In other words, the conduit, which may be a flexible coaxial cable or a flexible shielded trace, for example, that passes through the first hinge 224 such that the core wire 242, which is housed in the first posterior portion 222b, is in electrical communication with the radio 240 in the first anterior portion 222a, but the first hinge 224 is electrically isolated from the conduit. In such an implementation, the conduit is preferably flexible such that the first hinge 224 may rotate without damaging the conduit. Further, the first hinge 224 may be electrically isolated from the conduit due to properties of the conduit (i.e., an outer plastic layer of the coaxial cable or shielded trace), or by virtue of being coupled to a ground where the first hinge 224 is metal, or the first hinge 224 comprises electrically insulating material, which may be plastic.

In addition, implementations of the present disclosure include an antenna, a power source, and an electrically conductive path or wire placed in various locations within an eyewear frame. For example, FIG. 3 is a perspective view of an exemplary implementation of eyeglasses 300, which may be, in an implementation, substantially similar in structure to eyeglasses 100, except for differences described herein. For ease of recognition in the drawings, eyeglasses 300 are represented by dashed lines, and certain internal features, such as the frame portions and apertures of arms 318, 326, are not shown, although one of skill in the art will appreciate that such features are present within implementations of the eyeglasses 300.

The eyeglasses 300 include first and second arms 318 and 326 coupled to a front eyeglass frame 302. The front eyeglass frame 302 includes a first rim 304 and a second rim 310 securely physically coupled by a bridge 316. A radio 340 is housed internally in a first temple portion 322 of the first arm 318, and preferably within a first anterior portion 322a of the first temple portion 322 of the first arm 318. The radio is electrically coupled to, or in electrical communication with, a power source 346a.

In a preferred implementation, the power source 346a is housed internally within a second temple portion 328 of the second arm 326, and more preferably within a second anterior portion 328a of the second temple portion 328 of the second arm 326. The power source 346a may be a portable power source, such as a battery or a super-capacitor (i.e., capacitor with capacitance on the order of 0.01 F or greater). In addition, where the power source 346a is a battery, the battery can be rechargeable (i.e., a user inserts an external charging cord into eyeglasses 300 to charge the battery comprising the power source 346a), or replaceable (i.e., the eyeglasses 300 include a removable cover for removing and replacing the battery or batteries comprising the power source 346a). In implementations where the power source 346a is one or more replaceable batteries, circuitry may be housed within either of the arms 318 and 326, and more specifically within either of the first and second temple portions 322 and 328, to receive the battery or batteries and provide an electrical connection between the battery or batteries and the radio 340. In other words, the circuitry is communicatively coupleable to the replaceable battery or batteries comprising the power source 346a. However, one of skill in the art will appreciate that, in implementations where the power source 346a is a rechargeable battery or a super-capacitor, the same or substantially similar circuitry may be present to connect the power source 346a to the radio 340. The power source 346a is electrically coupled to the radio 340 by wire 348a to transmit electric current from the power source 346a to power the radio 340, as well as any other electronic components housed within the first temple portion 322 of the first arm 318.

In an implementation, the wire 348a passes internally from the power source 346a housed within the second temple portion 328, through a second aperture (not shown) in the second arm 326 similar to first aperture 236 (FIG. 2), the second rim 310, the bridge 316, the first rim 304, the first aperture 236 (FIG. 2) to the radio 340 in the first temple portion 322. The wire 348a can pass through any of the elements of the front eyeglass frame 302. For example, in various implementations the wire 348a passes internally through a second upper peripheral portion 312 of the second rim 310, the bridge 316, and a first upper peripheral portion 306 of the first rim 304. In other implementations, the wire 348a passes through a second lower peripheral portion 314 of the second rim 310, the bridge 316, and the first upper peripheral portion 306 of the first rim 304. In alternative implementations, the wire 348a passes through the second upper peripheral portion 312, the bridge 316, and a first lower peripheral portion 308 of the first rim 304. Accordingly, implementations of the present disclosure are not limited by the path of the wire 348a through the front eyeglass frame 302.

In other variations, the power source and wire are located within the first temple portion 318, along with the radio 340, as represented by dashed lines 346b and 348b, respectively. In such an implementation, the wire 348b preferably does not pass through any portion of the front eyeglass frame 302. Rather, the power source 346b is housed proximate the radio 340 and electrically coupled to radio 340 by wire 348b. It may even be possible to include the power source 346b within a first posterior portion 322b of the first temple portion 322 or a second posterior portion 328b of the second temple portion 328. In other words, in an implementation, the power source 346b is located within the first anterior portion 322b proximate a first distal end 344 of the first arm 318 or within the second anterior portion 328b of the second temple portion 328 proximate a second distal end 345 of the second arm 326.

A first core wire 342a, which may be substantially similar to core wire 242 illustrated in FIG. 2, is incorporated into the first arm 318 of the eyeglasses 300, and more preferably in at least a portion of the first posterior portion 322b. The first core wire 342a is communicatively coupled to the radio 340 as an antenna, as described herein. Preferably, the second arm 326 includes a second core wire 342b incorporated into the second posterior portion 328b such that at least each of the core wires 342a, 342b, and each of the posterior portions 322b, 328b are adjustable. More specifically, each of the core wires 342a, 342b is preferably repeatedly plastically deformable to retain at least the posterior portion in a shape without breaking when adjusted by the user, and each of the posterior portions 322b, 328b preferably comprises at least a flexible or adjustable material so as to enable shaping of the core wires 342a, 342b. In an implementation, only the first core wire 342a is communicatively coupled to the radio 340 as an antenna, with the second core wire 342b assisting with fitting the eyeglasses 300 to the head of the user. However, in other implementations, both core wires 342a, 342b are communicatively coupled to radios as antennas, such as may be the case when display-producing components are located in both arms 318, 326 (such as in a binocular display). In such implementations, both core wires 342a, 342b may be substantially similar, although they are not required to be. For example, a length or width of the first core wire 342a could be greater than, or less than, a length or width of the second core wire 342b.

Further, one of skill in the art will appreciate that although at least the posterior portions 322b, 328b are preferably deformable along with the core wires 342a, 342b, implementations of the present disclosure also include the posterior portions 322b, 328b and core wires 342a, 342b being stiff and inflexible, as well as other portions of the arms 318, 326 being deformable or flexible in addition to the posterior portions 322b, 328b. For example, in various implementations, at least one of the core wires 342a, 342b extends into a respective anterior portion 322a, 328a, wherein the respective anterior portion 322a, 328a is deformable or flexible, such that the anterior portion 322a, 328a is deformable according to the shape held by the core wire 342a, 342b. In other words, in certain implementations, one or both of the core wires 342a, 342b extends along at least a portion of a respective anterior portion 322a, 328b, wherein the core wires 342a, 342b are repeatedly plastically deformable to retain at least the posterior portion 322b, 328b in a shape, as well as the respective anterior portion 322a, 328b in the shape.

The phrase “repeatedly plastically deformable” as used herein with reference to various implementations of core wires refers to a material's ability to have its shaped changed by a user several times without breaking, wherein after the user changes the shape of the material, the material retains the shape. Put another way, “repeatedly plastically deformable” includes materials which may be deformed from an original position at least two times or more without breaking or fracture, wherein after the material has been deformed, the material holds the deformed shape. In various implementations, the repeatedly plastically deformable material comprising at least one of the core wires 342a, 342b is deformable at least three times, at least four times, at least five times, at least six times, at least seven times, at least eight times, at least nine times, at least ten times, at least fifteen times, at least twenty times, at least thirty times, at least forty times, at least fifty times, at least seventy-five times, at least one hundred times, at least five hundred times, or at least one thousand times without breaking or fracturing, wherein after each deformation, the repeatedly plastically deformable material retains the shape imparted by the user via the deformation.

In an implementation, the core wire 342a is electrically communicatively coupled to the radio 340 as an antenna operative to wirelessly transmit radio frequency signals that embody an established wireless communication protocol, for example, without limitation: Bluetooth®, Bluetooth® Low-Energy, Bluetooth Smart®, ZigBee®, WiFi®, Near-Field Communication (NFC), or the like. Such protocols typically employ radio frequency signals in the range of 1 GHz to 10 GHz (with the exception of NFC, which operates in the 10 MHz-20 MHz range) and may include pairing or otherwise establishing a wireless communicative link between an apparatus, such as a wearable heads-up display carrying the core wire 342a, and another external electronic device.

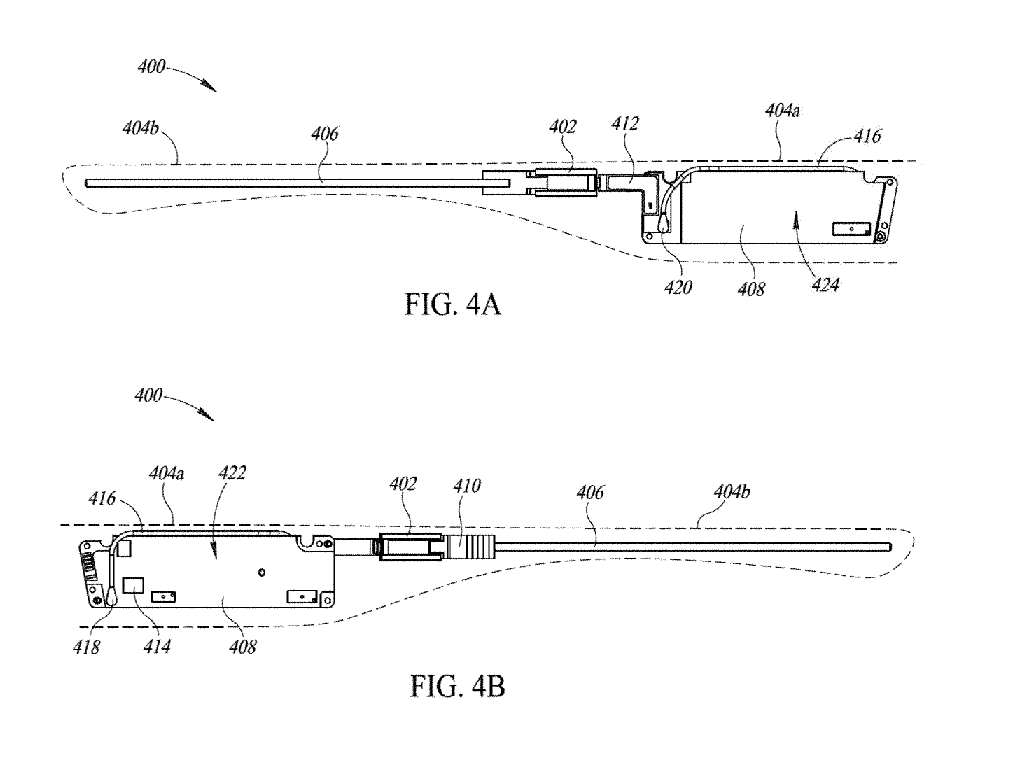

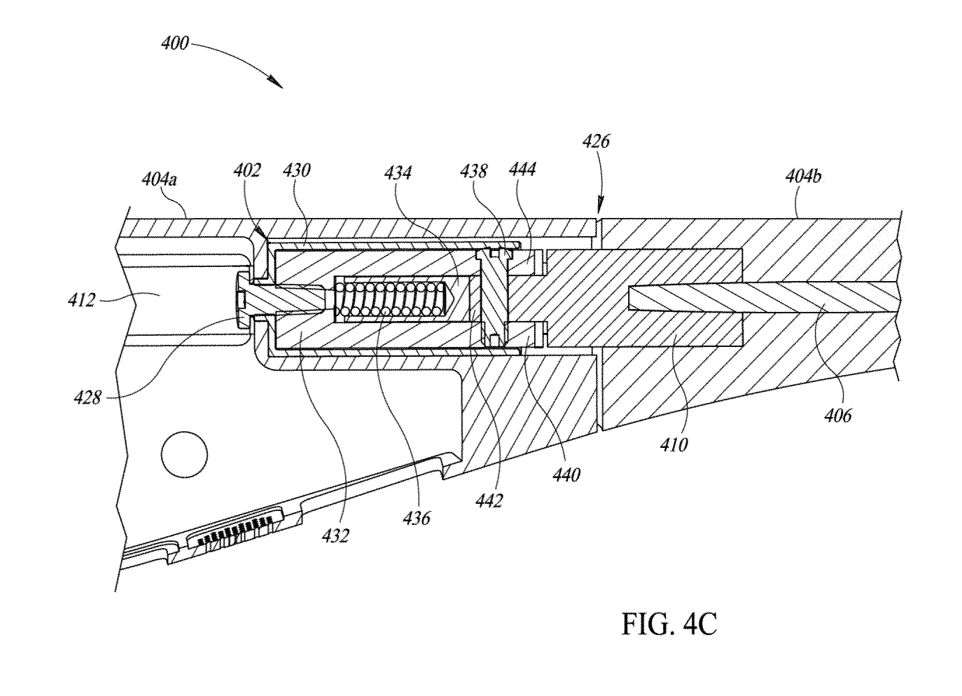

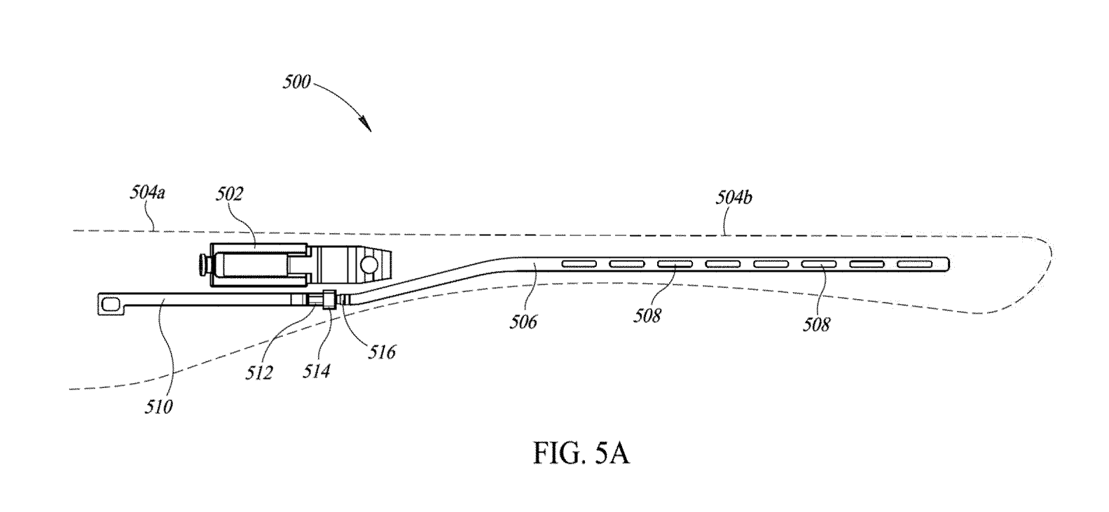

FIGS. 4A and 4B illustrate left and right side views, respectively, of an electrically conductive path housed within a temple portion 400 of an arm including at least a core wire 406 and a portion of a hinge 402. The temple portion 400 is illustrated here in dashed lines so as to avoid obscuring implementations of the electrically conductive path, although one of skill in the art will readily appreciate that temple portion 400, including the electrically conductive path, may be substantially similar to temple portions 322, 328 in FIG. 3 or temple portions 122, 128 in FIG. 1. In an implementation, the temple portion 400 replaces at least one of temple portions 122, 128, 322, or 328, while in other implementations; the temple portion 400 replaces at least two of, at least three of, or all of temple portions 122, 128, 322, or 328. As such, temple portion 400 may be coupled to a frame portion as in FIG. 2 and further incorporated into eyeglasses 100, 300, although not specifically illustrated as such.

The temple portion 400 includes a hinge 402 between an anterior portion 404a and a posterior portion 404b of the temple portion 400. The temple portion 400 further includes a printed circuit board 408, which in an implementation is housed in the anterior portion 404a and thermally conductively coupled to metal sidewalls of the anterior portion 404a. The core wire 406 is electrically and physically coupled to the hinge 402 via a connector 410. The hinge 402 is electrically coupled to the printed circuit board 408 via element 412, which may be a wire, metal strip, or other electrically conductive device. A radio 414 is carried by the printed circuit board 408 and electrically coupled to the element 412 and the hinge 402 via path 416. In an implementation, path 416 extends from a first contact 418 on a first major face 422 of the printed circuit board 408 to a second contact 420 on a second major face 424 of the printed circuit board. The element 412 is electrically coupled to, or in electrical communication with, the second contact 420, and the radio 414 is electrically coupled to, or in electrical communication with, the first contact 418. In various implementations, the path 416 is one of a wire, a coaxial cable, or a shielded trace on the printed circuit board 408.

Because the radio 414 is operative to at least one of transmit or receive signals, and is electrically coupled to electrically conductive traces (not shown) on the printed circuit board 408 as described herein, when the radio 414 sends a signal, the signal passes from radio 414 to first contact 418 on the printed circuit board 408, through path 416 to the second contact 420, to element 412, to the hinge 402, and into core wire 406 for amplification. Alternatively, when a signal is received by the core wire 406, the signal passes through the temple portion 400 in reverse, to be received by the radio 414. As such, at least a portion of each of the radio 414, printed circuit board 408, path 416, element 412, hinge 402, and core wire 406 may be included in an electrically conductive path housed in the temple portion 400.

Further, as illustrated in FIGS. 4A and 4B, the core wire 406 is physically and electrically coupled to hinge 402 by the connector 410 and the core wire 406 extends along at least a portion of the posterior portion 404b of the temple portion 400. The core wire 406 extends along the posterior portion 404b according to its length, which as described herein, preferably corresponds to a reciprocal integer of a wavelength of a signal received or transmitted by the radio 414. As such, implementations of the present disclosure include the core wire 406 extending along less than half, more than half, or along substantially all of the posterior portion 404b.

FIG. 4C is a cross-sectional view showing the electrically conductive path through the hinge 402 in additional detail. FIG. 4C illustrates the hinge 412 between the anterior portion 404a and the posterior portion 404b, wherein the anterior portion 404a and the posterior portion 404b are separated by a gap or space 426, with the hinge 402 extending through the gap 426, such that the hinge 402 is between the anterior portion 404a and the posterior portion 404b. The core wire 406 is electrically and physically coupled to the connector 410, and the element 412 is electrically physically coupled to the hinge 402.

In an implementation, the hinge 402 is a spring hinge including an outer housing 430 coupled to an inner housing 432 by a first fastener 428. The first fastener 428 couples the element 412 to the outer housing 430 as well. A spring 436 is housed in the inner housing 432. Preferably, the spring 436 is housed in a spring housing 434 that is coupled to, and received by, the inner housing 432. The inner housing 432 further includes at least a first barrel 440 and a third barrel 444. The first and third barrels 440, 444 are in spaced physical relationship to receive a second barrel 442, which is part of, or coupled to, the connector 410. In order words, the second barrel 442 has a size and a shape to be received by a space between first and third barrels 440, 444. Each of the barrels 440, 442, 444 are coupled by a second fastener 438 passing through each of the barrels 440, 442, 444. As such, when the hinge 402 is manipulated between an open and closed configuration, at least the second barrel 442 rotates relative to the first and third barrels 440, 444, wherein such rotation is aided by the spring 436.

As such, an electrically conductive path passing through the hinge 402 may pass through only a portion of the hinge 402, depending on which features of the hinge 402 comprise electrically conductive material. In an implementation, all of the elements of the hinge 402 are electrically conductive. However, in other implementations, the electrically conductive path takes a more specific path through the hinge 402 from the element 412 to the connector 410 and the core wire 406, wherein only certain features of the hinge 402 are electrically conductive.

For example, in an implementation, the electrically conductive path passes through a portion of the hinge 402 including the first fastener 428, the outer housing 430, the second fastener 438, and the second barrel 442. In another implementation, the electrically conductive path passes through a portion of the hinge 402 including the outer housing 430, the second fastener 438, and the second barrel 442. In a further implementation, the electrically conductive path passes through a portion of the hinge 402 including the outer housing 430, the inner housing 432 (including the first and third barrels 440, 444), and the second barrel 442. In still further implementations, the electrically conductive path passes through a portion of the hinge 402 including the first fastener 428, the inner housing 432, the spring housing 434, and the second barrel 442, wherein the first and third barrels 440, 444 are electrically isolated from the electrically conductive path. In yet a further implementation, the spring housing 434 and spring 436 are coupled to the second barrel 442, and the electrically conductive path includes at least a portion of the first barrel 440, a portion of the second barrel 442, and the spring 436. As such, it is to be understood that the electrically conductive path through the hinge 402 may include only a portion of, or all of, the features of the hinge 402, and implementations of the present disclosure are not limited to specific paths through the hinge. Moreover, certain features that are not described as being part of the electrically conductive path in a given implementation may be comprised of metal coupled to a ground, or electrically insulating material, which may be plastic, among others.

In an alternative implementation, the hinge 402 is a barrel hinge. In such an implementation, the hinge 402 does not include the spring 436 or the spring housing 434. Instead, the hinge 402 comprises at least one housing, which may be either the outer housing 430, inner housing 432, or a combination thereof where the outer housing 430 and inner housing 432 are a single, unitary, integral component, and at least three barrels 440, 442, 444. The element 412 is coupled to the housing with the first fastener 428, and the barrels 440, 442, 444 are rotatably coupled by the second fastener 438. As such, in implementations where the hinge 402 is a barrel hinge, the electrically conductive path includes at least a portion of each of the first fastener 428, the housing (including at least a portion of one of the barrels 440, 444), the second barrel 442 and optionally, the second fastener 438. In such implementations where the electrically conductive path includes the hinge 402, it is preferable that the impedance of the various electrical couplings within the electrically conductive path is substantially similar, which in this context means within 3 ohms. Adjusting the impedance may include one or both of adjusting dimensions of the components of the hinge 402, or changing materials comprising the components of the hinge 402 that are included in the electrically conductive path until the impedance is substantially similar.

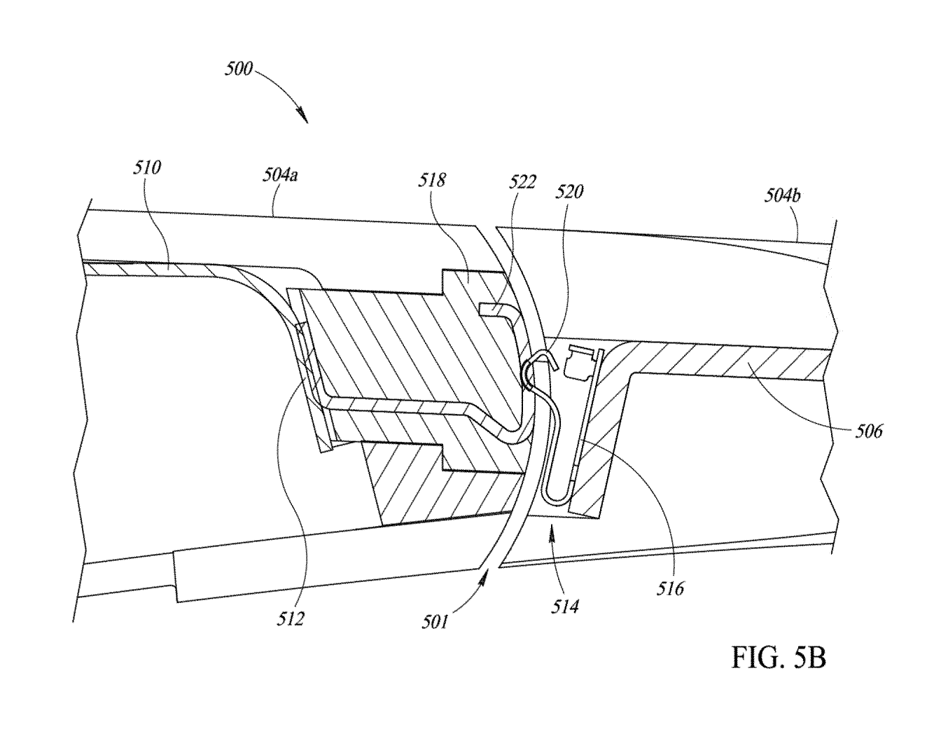

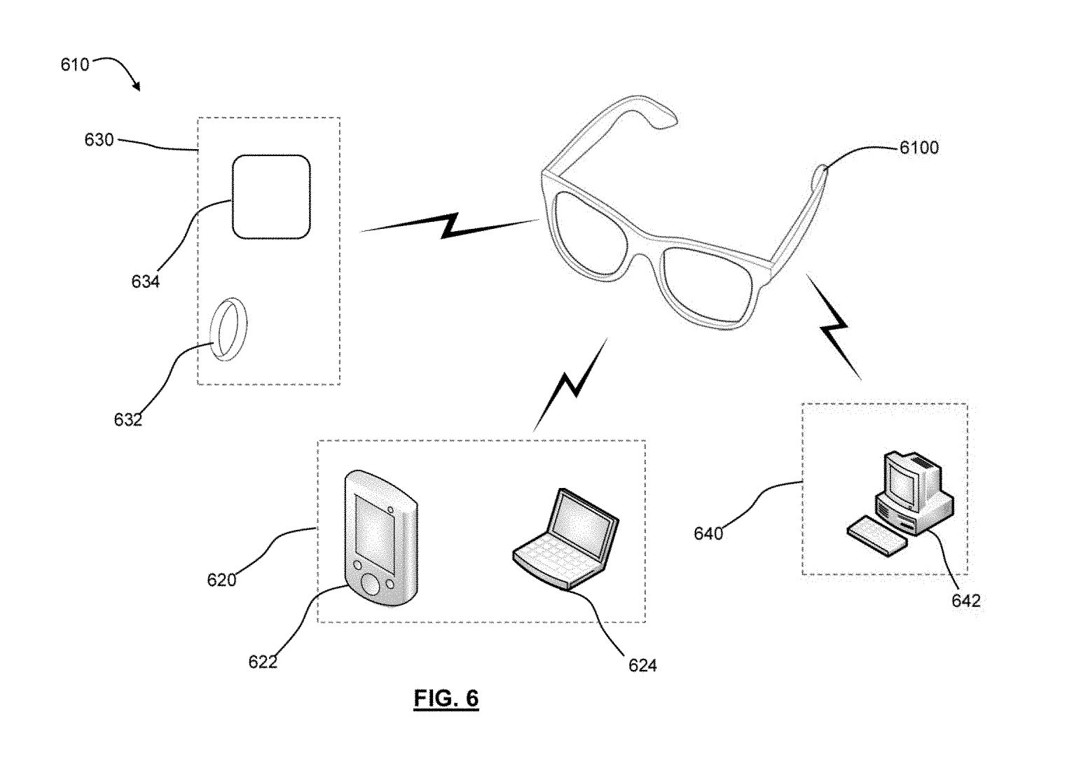

Implementations of the present disclosure also include the hinge 402 being electrically isolated from the electrically conductive path, as in FIG. 5A. FIG. 5A is a right side view of an alternative implementation of temple portion 500 of an arm of a pair of eyeglasses, such as eyeglasses 100, 300, including a hinge 502 between an anterior portion 504a and a posterior portion 504b of the temple portion 500. A core wire 506 is integrated into the temple portion 500 and extends along at least a portion of the posterior portion 504b. Further, the core wire 506 may include one or more apertures 508 along its length. An electrically conductive path that is electrically isolated from the hinge 502 may include a conduit 510 (which may be electrically coupled to a printed circuit board (not shown), such as printed circuit board 408), a first contact 512 proximate the hinge 502 in the anterior portion 504a, a pin 514, and a second contact 516 proximate the hinge 502 in the posterior portion 504b, wherein the core wire 506 is electrically coupled to the second contact 516. Importantly, however, the hinge 502 in such an implementation is electrically isolated from the electrically conductive path, either by virtue of the hinge 502 being coupled to a ground (not shown) when the hinge 502 includes metal, or because one or more components of the hinge 502 comprise electrically insulating material, which may be plastic.

FIG. 5B is a cross-section of temple portion 500 showing a portion of the electrically conductive path in additional detail. The temple portion 500 includes the anterior portion 504a and the posterior portion 504b, with the pin 514 extending across a space 501 between the anterior and posterior portions 504a, 504b. The pin 514 includes a first pin portion 520 electrically and physically coupled to the second contact 516, and a second pin portion 522 electrically coupled to the first contact 512. The first contact 512 is electrically coupled to the conduit 510. In an implementation, the conduit 510 terminates at the first contact 512, such that the first contact 512 is a part of the conduit 510. The second contact 516 is electrically coupled to the core wire 506. In an implementation, the second contact 520 is part of the first pin portion 520, although in other implementations, the second contact 520 is a separate structure between the first pin portion 520 and the core wire 506. As such, the first pin portion 520 is electrically coupled to the core wire 506, and the second pin portion 522 is electrically coupled to the conduit 510.

The pin 514 may be protected by a housing 518, wherein the housing 518 is received by the anterior portion 504a and surrounds at least a portion of, or substantially all of, the second pin portion 522. In this context only, “substantially all of” means every surface of the second pin portion 522 except one exposed surface. The pin 514 may be manipulated by a user via rotating the posterior portion 504b about the hinge (not shown) between an unfolded configuration and a folded configuration. In the folded configuration, the pin 514 electrically isolates the first contact 512 from the second contact 516. In an implementation, the isolation includes the second pin portion 522 being removably coupled to the first contact 512 and electrically and physically coupled to the first pin portion 520, such that rotation of the posterior portion 504b removes the second pin portion 522 from contact with the first contact 512, thereby electrically isolating the first contact 512 from the second contact 516. In such an implementation, the second pin portion 522 may move within the housing 518 (i.e., is removably coupled to the housing 518) or the housing 518 may be removably coupled to the anterior portion 504a (i.e., the second pin portion 522 is physically coupled to the housing 518).

In other implementations, the second pin portion 522 is physically and electrically coupled to the first contact 512 and removably coupled to the first pin portion 520 such that rotation of the posterior portion 504b electrically isolates the pin portions 520, 522 and therefore the contacts 512, 516. In still a further implementation, the folded configuration includes the first contact 516 electrically isolated from core wire 506 by virtue of the first contact 516 being removably coupled to the core wire 506 and physically and electrically coupled to the first pin portion 520, such that rotation of the posterior portion 504b to the folded configuration includes the first contact 516 being electrically isolated from the core wire 506.

In the unfolded configuration, as shown in FIG. 5B, the electrically conductive path includes the conduit 510, the first contact 512, the first and second pin portions 520, 522, the second contact 516, and the core wire 506. The hinge (not shown) may be electrically isolated from the electrically conductive path as described herein. In other words, rotation of the posterior portion 504b to the unfolded configuration establishes an electrical connection between components of the pin 514, the conduit 510, and core wire 506 via first and second contacts 512, 516. Further, the conduit 510 may be one of a coaxial cable or a shielded trace, among other alternatives.

The various implementations described herein provide a compact, aesthetically pleasing glasses form factor that includes an antenna and a radio for enabling inter-device connectivity. Further, such glasses form factor enables efficient and automated manufacturing, as well as a highly directional antenna, in order to increase connectivity range. A location, orientation and position of a power source and an electrically conductive path between the power source and the radio and antenna are adjustable to reduce interference. In addition, the directionality of the antenna reduces interference with metal components which may be proximate to the antenna in the glasses form factor, thereby limiting any interference from such metal components while also enabling efficient heat dissipation from heat produced by the electronic components in the glasses form factor. As a result, implementations of the present disclosure allow for optimization of the connectivity, range, and signal strength of the antenna when transmitting or receiving signals from other electronic devices. In particular, implementations of the present disclosure enable optimal connectivity, range, and signal strength characteristics for the antenna and the radio regardless of the position of an external device within a given range.

Turning now to FIG. 6, illustrated therein is a system 610 incorporating a wearable heads-up display (“WHUD”) 600 in wireless communication with at least one other electronic device in accordance with the present systems, devices, and methods. In particular, in this implementation the WHUD 6100 may be in wireless communication with one or more portable electronic devices 620, such as a smartphone 622 or a laptop 624. Other exemplary portable electronic devices could include an audio player, a tablet computer, an ebook reader, and so on.

As shown, in this implementation the WHUD 6100 may also be in wireless communication with one or more wearable electronic devices 630, such as an electronic ring 632 or other wearable device 634. Generally, a wearable electronic device may be attached or coupled to the user by a strap or straps, a band or bands, a clip or clips, an adhesive, a pin and clasp, an article of clothing, tension or elastic support, an interference fit, an ergonomic form, etc. Other examples of wearable electronic devices include digital wristwatches, electronic armbands, electronic ankle-bracelets or “anklets”, hearing aids, and so on.

As also shown, in this implementation the WHUD 6100 may also be in wireless communication with one or more other electronic devices 640 that are generally considered to be non-portable electronic devices, such as a computer workstation 642. Other examples of such electronic devices could include objects with a large mass or which are generally difficult for a user to hold and carry either due to the size and configuration, or being attached to something, and could include smart televisions, vehicles, smart devices (e.g., appliances such as smart fridges, smart thermostats, or hazardous condition detectors such as smoke alarms), and so on.

Generally speaking, the WHUD 6100 and electronic devices 620, 630, and 640 are in wireless communication to permit the exchange of data therebetween, which could include the exchange of control data, media data, information to be displayed to the user of the WHUD 6100 (i.e., via the display), or other types of data. For instance, the electronic ring 632 could be in wireless communication with the WHUD 6100 to control information being displayed on the transparent combiner of the WHUD 6100. This could allow a user to cycle through a menu of possible commands, for instance, or take some other action.

In some instances, one or more of the electronic devices 620, 630, and 640 could be in wireless communication with each other, regardless of whether they are in communication with the WHUD 6100. For instance, the electronic ring 632 could be in wireless communication with the smartphone 622 to control one or more aspects of the smartphone 622.

Generally speaking, wireless communication within the system 610 can be accomplished using any suitable communication protocol. Some communication protocols may be particularly suitable for use within the system 610, since they may be low power consuming protocols that are well suited for short distance wireless communication. Two examples might include ZigBee and Bluetooth®. For instance, one or more of the electronic devices 620, 630, and 640 and WHUD 6100 may include a Bluetooth® Low Energy chip having a signal frequency of about 2400 MHz to about 2500 MHz.

In some implementations, wireless communication within the system 610 can operate using signals having a frequency in a band of 100 MHz, 200 MHz, 300 MHz, 400 MHz, 800 MHz, and 900 MHz.

One of the challenges with facilitating wireless communication within the system 610 relates to the performance of the various components used to send and receive wireless signals, particularly the antenna.

Generally speaking, an antenna is a function of its environment, and its performance can vary greatly depending on whether the antenna is being used is a laboratory environment with minimal interference, or in the real world in the presence of a user. Quite notably, an antenna tends to be affected by everything around it, including materials and surrounding equipment in an electronic device that includes the antenna, but also aspects of the surrounding environment, including the presence of the user. Specifically, the radiated electromagnetic (EM) fields from an antenna interact with nearby materials, which can alter the frequency of operation of the antenna or change its input impedance. This, in turn, can induce a mismatch with the driving power amplifier (e.g., transmitter) or receiving low noise amplifier (e.g., receiver). As a result, to develop reliable antenna performance, the antenna should be tested in its final environment (or a reasonable approximation thereof) and impedance matched so that it operates well within the desired frequency band. A poorly matched antenna on the other hand can degrade the system link budget by 10-30 dB thus severely reducing the overall link range.

For the system 610 described above, it is generally desirable to understand the various use cases around how a user will be interacting with the WHUD 6100 and the other electronic devices 620, 630, and 640. For example, some wearable components such as the electronic ring 632 may be worn by the user of the WHUD 6100 at times, while others such as a smartphone 622 may typically be carried in a pocket. Similarly, the communication distance between a user of the WHUD 6100 and the electronic devices 620, 630, and 640 can vary. In some cases, it may be sufficient to have a working communication range of approximately 10 meters or less to facilitate effective wireless communication between the WHUD 6100 and one or more electronic devices 620, 630, and 640. In some implementations it may be desirable to have a higher working range greater than 10 meters, greater than 20 meters, or even larger. In some cases, it may be suitable to have a smaller working range, such as less than 5 meters, less than 3 meters, and so on. In some cases the effective working communication range can be varied by adjusting the power of the communications modules within the system 610.

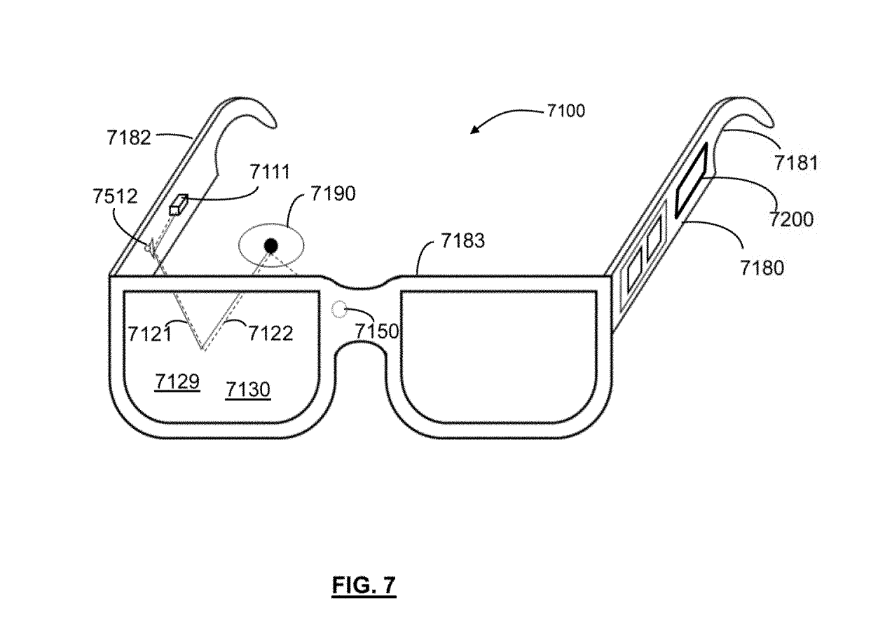

Turning now to FIG. 7, illustrated therein is a perspective view of an exemplary WHUD 7100 operable for wireless communication with electronic devices, such as electronic devices 620, 630 and 640. WHUD 7100 as shown includes elements such as a projector 7111 (i.e., a laser module) adapted to output a visible laser light 7121 (e.g., in at least a first narrow waveband). In some cases, the projector 7111 may be operable to output infrared laser light 7122, and optionally an oscillating scan mirror or reflector 7512. The WHUD 7100 also includes a display component that enables the user to see displayed content but also does not prevent the user from being able to see their external environment. As shown, the display component could include a transparent combiner 7130 (aligned with an eyeglass lens 7129) which redirects the laser light 7121 and 7122 towards an eye 7190 of a user. In some implementations, the WHUD 7100 may include at least one infrared photodetector 7150 responsive to infrared laser light 7122.

Depending on the implementation, the visible laser light 7121 may correspond to any of, either alone or in any combination, red laser light, a green laser light, and/or a blue laser light.

WHUD 7100 also includes a support frame 7180 that has a general shape and appearance or a pair of eyeglasses, so that transparent combiner 7130 is positioned within a field of view of an eye 7190 of the user when support frame 7180 is worn on a head of the user. The support frame 7180 typically includes two support arms 7181, 7182 extending rearwardly from a front rim portion 7183 that supports the eyeglass lens 7129 and transparent combiner 7130. The rim portion 7183 is normally supported by a nose of the user, while the support arms 7181, 7182 are normally supported by the ears of the user.

WHUD 7100 further includes a digital processor 7160 communicatively coupled to photodetector 7150 (in this example), and a non-transitory processor-readable storage medium or memory 7170 communicatively coupled to digital processor 7160. Memory 7170 stores processor-executable instructions and/or data that, when executed by processor 7160, can cause processor 7160 to take actions, such as determining one or more position(s) and/or movement(s) of eye 7190, determining what information to display on the transparent combiner 7130, and managing communication between the WHUD 7100 and one or more electronic devices 620, 630 and 640.

In particular, WHUD 7100 further includes a communication module 7200 for wireless communication with other electronic devices, and which may be communicatively coupled to the digital processor. Generally speaking, according to the teachings herein, one or more components of the communication module 7200 may be integrated within one or more components of the support frame 7180. For instance, the communication module 7200 may be at least partially integrated within one or both of the support arms 7181, 7182. The communication module 7200 may be at least partially integrated within the rim portion 7183 of the support frame 7180. In some examples, the communication module 7200 may be at least partially integrated within some combination of the support arms 7181, 7182 and the rim portion 7183.

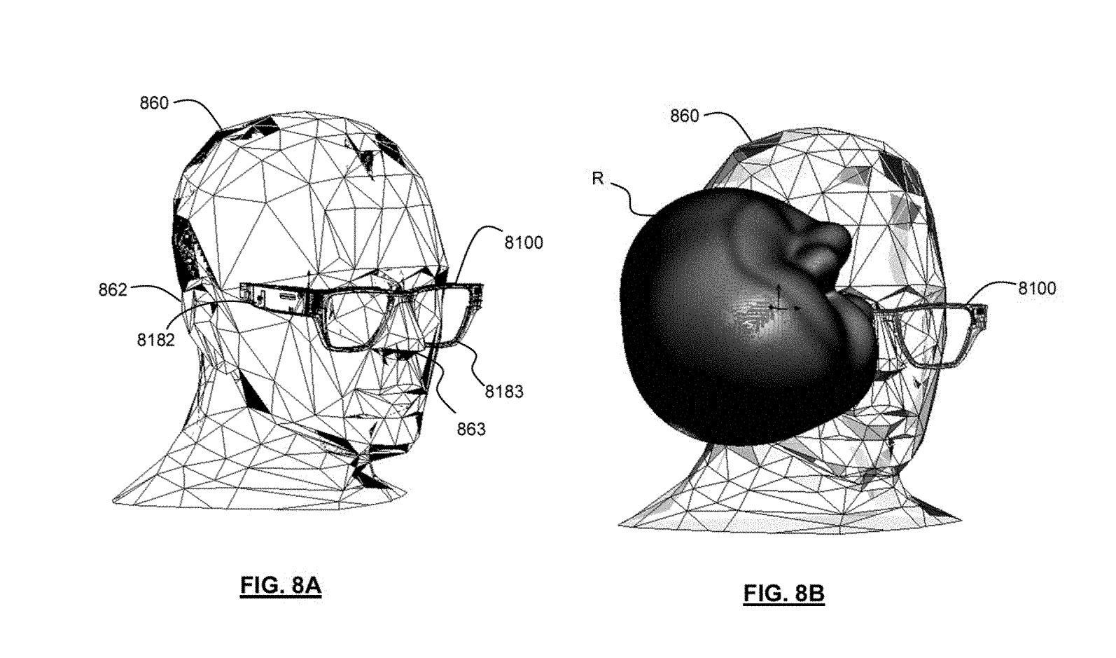

Generally speaking, the communication module 7200 includes a radio frequency (RF) antenna for the signals transmitted and received via the communication network. For example, FIG. 8A shows the WHUD 8100 mounted on a head 860 of a user, with the support arm 8182 being supported by an ear 862 and the rim portion 8183 being supporting by a nose 863. FIG. 8B on the other hand shows an exemplary EM pattern “R” generated by an antenna in the WHUD 8100.

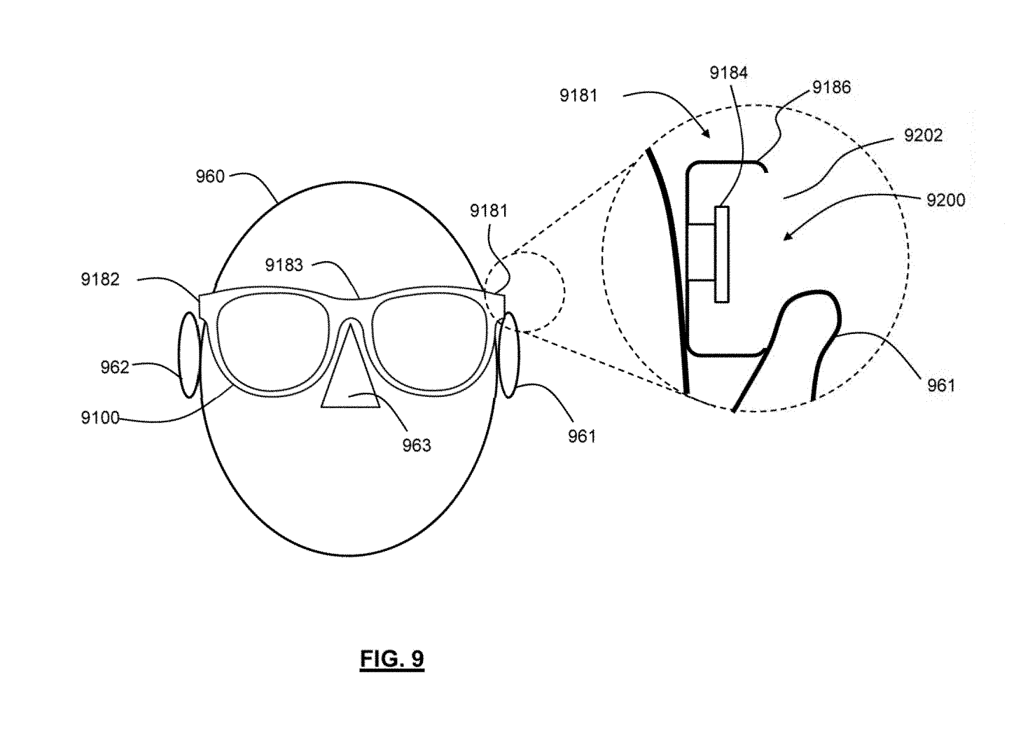

Turning now to FIG. 9, the WHUD 9100 mounted on the user's head 960 is shown schematically in greater detail. As shown, the WHUD 9100 is mounted on the head 960, with the arm supports 9181, 9182 being supported by ears 961, 962 (respectively) and the rim portion 9183 being supported by nose 963.

Shown enlarged in is a schematic cross-section of the arm portion 9181 having an integrated communication module 9200 therein. In particular the arm support 9181 generally includes a first body member 9186 that typically extends lengthwise of the arm support 9181, and which serves as a housing for components of the WHUD 9100, such as a printed circuit board (PCB) 9184, which may include the digital processor 9160, memory 9170, and so on. The first body member 9186 may be made of any suitable material, such as a plastic or a metal.

The arm support 9181 also includes a second body member 9202 which is designed to serve as a resonating element or antenna of the communication module 9200. As shown schematically, the second body member 9202 may be electrically and/or mechanically isolated from the first body member 9185. The second body member 9202 may in some implementations comprise a conductive material, such as a metal plate element that resonates in response to instructions received from the digital processor 9160 to send wireless signals to one or more electronic devices 620, 630 and 640. Moreover, the second body member 9202 may also resonate in response to signals received from the electronic devices 620, 630, and 640 to act as a receiving antenna.

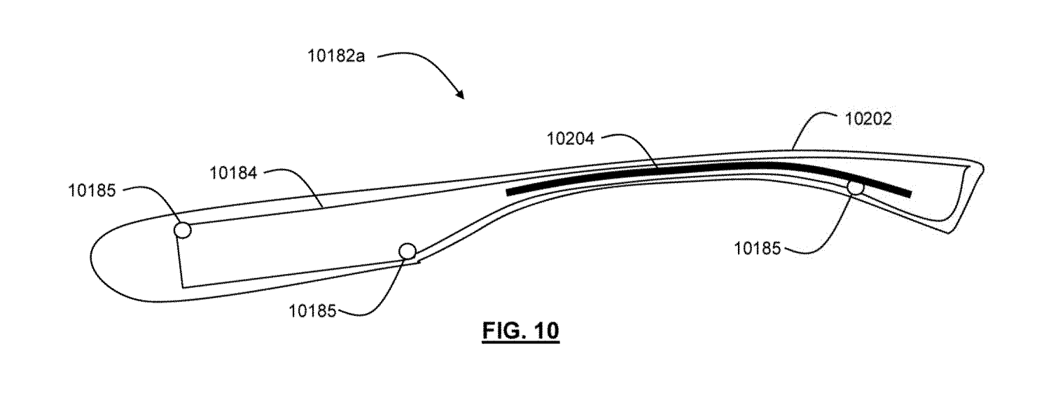

Turning now to FIG. 10, illustrated therein is an example of an arm support 10182a having integrated components of the communication module. In particular arm support 10182a includes PCB 10184 which is mounted to the first body member (not shown in FIG. 10), such as via mounting screws 10185. In this implementation, the communication module includes a wire antenna 10204 which is housed within the arm support 10182a. In some implementations, the wire antenna 10204 may be coupled to the second body member 10202 to cooperate therewith as an antenna for the WHUD.

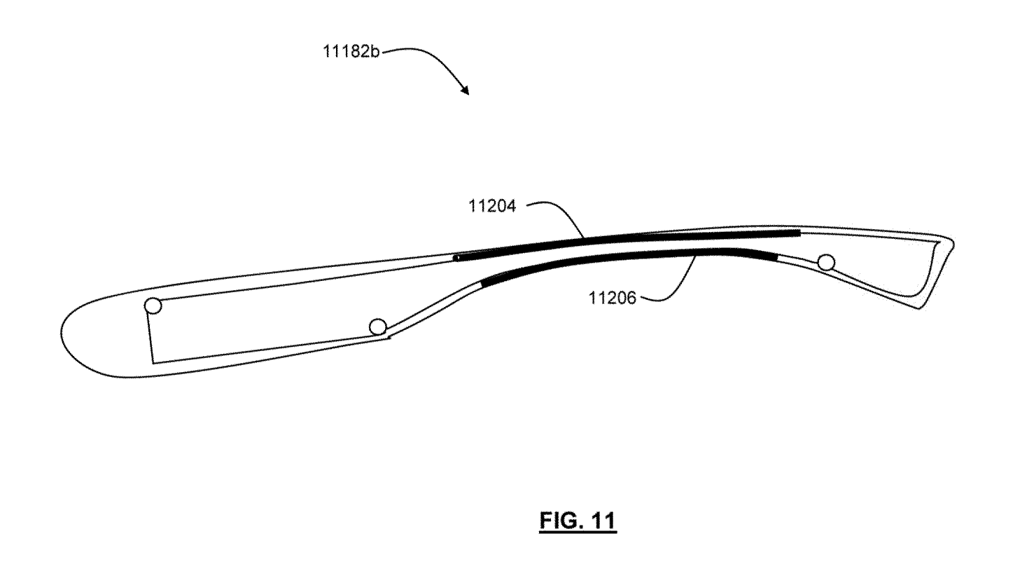

Turning now to FIG. 11, illustrated therein is an example of another arm support 11182b having integrated components of the communication module. In this implementation, the arm support 11182b includes the wire antenna 11204 as well as a grounding element 11206 for increasing the ground plane.

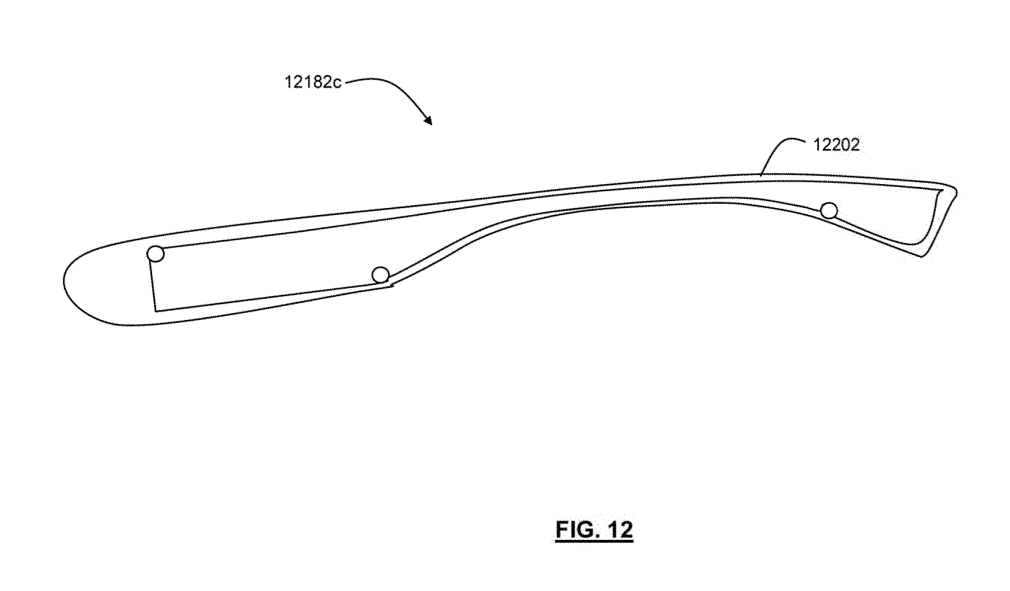

Turning now to FIG. 12, illustrated therein is an example of another arm support 12182c having integrated components of the communication module. In this implementation, the second body portion 12202 serves as the antenna for the communication module without requiring an internal wire antenna.

Since the antenna will be worn but a user, it will be in close proximity to the user's body. By being in close proximity to the user's body, the user's body can affect the input impedance. In some cases, the length of the antenna can be designed to minimize this input impedance. In particular, the length of the antenna can be designed to consider impedance matching. Generally, an ideal length of the antenna is nλ/2, wherein λ is the wavelength of a signal guided.

In addition to selecting an appropriate length for the antenna, matching will also be provided by an impedance matching module on the PCB.

One of the challenges observed, however, with some of the preceding implementations relates to the nature of antennae. In particular, as discussed above an antenna is a function of its environment, and its performance can vary greatly depending on the operating environment. In designing a WHUD, however, it can be difficult to develop a comfortable “one size fits all” arrangement where the size and shape of all the components, particularly the arm supports, is constant. In fact, in contrast, it has been observed that it may be desirable to offer WHUDs in multiple shapes and sizes to accommodate different sizes and shapes of the heads of different users.

Returning to FIG. 9, this means that the respective lengths of the arm portions 9181, 9182 is sometimes different, in some case quite different. As a result, this can have a dramatic impact on the performance of the antenna. Although it may be possible to have a second body portion 9202 that is the same for each of the different sizes of arm portions 9181, 9182, this can lead to aesthetic challenges as differently sized WHUDs 9100 may have a vastly different appearance.

According to another implementation of the teachings herein, one or more of the arm supports 9181, 9182 may incorporate a multi-piece construction, wherein the antenna elements of the communication module 9200 are incorporated in first piece that has a common size and shape, and the other portion of the arm supports 9181, 9182 can vary in length.

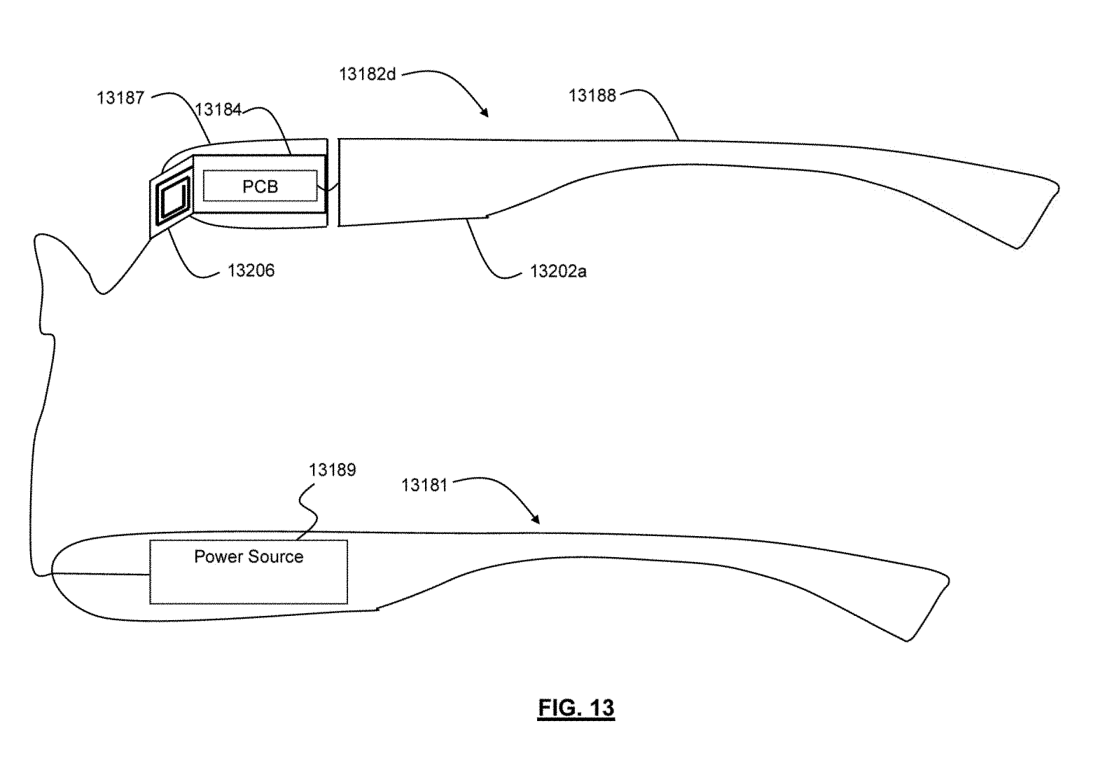

One example of such an embodiment is shown schematically in FIG. 13. In this example, the arm support 13182d includes a first forward portion 13187, and a second rearward portion 13188. The forward portion 13187 may be positioned adjacent (or even be part of) the rim support, and may include the PCB 13184. As shown, the forward portion 13187 includes an antenna 13206 (shown here as a spiral antenna). The forward portion 13187 can generally have a consistent shape and size, regardless of the sizing required to accommodate a particular head of a user.

The rearward portion 13188 of the arm support 13182d, on the other hand, can have a size and shape that is selected to accommodate the sizing requirements for the user's head. For instance, in larger WHUDs, the rearward portion 13188 could be longer, while in smaller WHUDs the rearward portion 13188 could be smaller.

In some implementations, the rearward portion 13188 could include a body member 13202a (i.e., a metal plate), which could be used to extend the ground plane.

As shown in FIG. 13, in this implementation the other arm support 13181 could support a power source 13189 (i.e., a battery) which provides power to the components in the arm support 13182d.

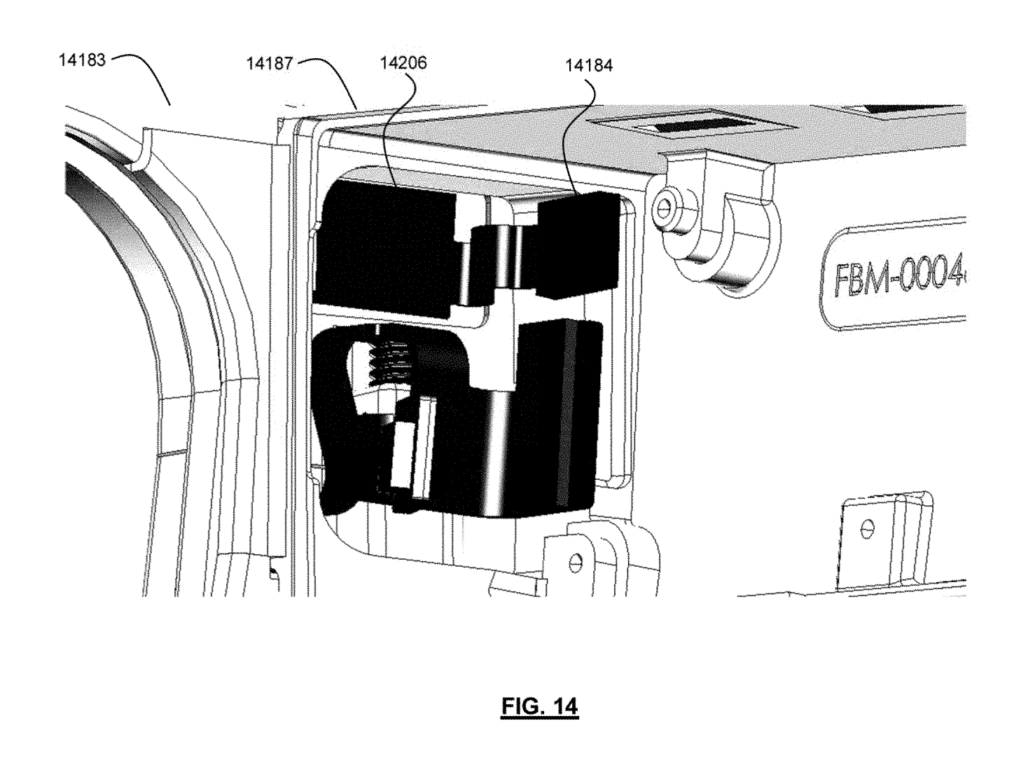

Turning now to FIG. 14, illustrated therein is a close up view of an exemplary implementation, wherein the forward portion 14187 may be part of or coupled to the rim support 14183. In this implementation, the antenna 14206 is located in the front area of the forward portion, and is coupled to the PCB 14184 via a flex connector.

Throughout this specification and the appended claims, the term “about” is sometimes used in relation to specific values or quantities. For example, “light within a bandwidth of about 10 nm or less.” Unless the specific context requires otherwise, the term about generally means±15%.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other portable electronic devices, and not necessarily the exemplary eyeglass frames or wearable heads-up displays generally described above.

For instance, the foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any computer-readable medium for use by or in connection with any processor-related system or method. In the context of this disclosure, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other nontransitory media.

Many of the methods described herein can be performed with variations. For example, many of the methods may include additional acts, omit some acts, and/or perform acts in a different order than as illustrated or described.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to U.S. Provisional Patent Application Ser. No. 62/670,200, U.S. Provisional Patent Application Ser. No. 62/236,060, U.S. Non-Provisional patent application Ser. No. 15/282,535 (now US Patent Application Publication 2017/0097753), U.S. Non-Provisional patent application Ser. No. 15/799,642 (now US Patent Application Publication 2018/0067621), U.S. Provisional Patent Application Ser. No. 62/609,607, and U.S. Provisional Patent Application Ser. No. 62/634,654 are incorporated herein by reference, in their entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. An apparatus, comprising:
a front eyeglass frame, including: a first rim, a second rim, and a bridge that physically couples the first rim and the second rim;
a first arm coupled to the first rim and having a first temple portion including an anterior portion and a posterior portion;
a second arm coupled to the second rim;
a radio operable to at least one of receive or transmit wireless signals; and
a core wire housed in the first arm and that extends along at least a portion of the posterior portion of the first temple portion, the core wire repeatedly plastically deformable without breaking to retain at least the posterior portion in a shape, the core wire communicatively coupled to the radio as an antenna.

2. The apparatus of claim 1 wherein the radio is operable to at least one of receive or transmit wireless signals at a first wavelength, and the core wire has a length that is at least approximately equal to a reciprocal of an integer of the wavelength.

3. The apparatus of claim 2 wherein the core wire has a length that is at least approximately equal to ¼, ⅓, or ½ of the wavelength.

4. The apparatus of claim 1 wherein a length of the antenna is between 30 millimeters and 63 millimeters.

5. The apparatus of claim 1 wherein at least a piece of the posterior portion is metal, and is coupled to a ground.

6. The apparatus of claim 1 further comprising:
a hinge between the anterior portion and the posterior portion; and
a printed circuit board in electrical communication with the core wire.

7. The apparatus of claim 6 wherein the core wire is electrically coupled to the hinge and extends from the hinge along at least the portion of the posterior portion of the first temple portion.

8. The apparatus of claim 7, further comprising:
an electrically conductive path from the printed circuit board to the core wire passing through at least the portion of the posterior portion, a portion of the hinge, and a portion of the anterior portion of the first temple portion.

9. The apparatus of claim 8 wherein the electrically conductive path includes: the printed circuit board housed in the anterior portion, the radio carried by the printed circuit board, the hinge, a conduit electrically connecting the hinge and the printed circuit board, and the core wire electrically coupled to the hinge.

10. The apparatus of claim 9 wherein the conduit is one of a coaxial cable electrically coupled between the printed circuit board and the hinge and a shielded trace carried by at least one layer of the printed circuit board.

11. The apparatus of claim 6 further comprising:
an electrically conductive path between the printed circuit board and the core wire passing through at least the portion of the posterior portion and a portion of the anterior portion of the first temple portion, wherein the hinge is electrically isolated from the electrically conductive path.

12. The apparatus of claim 11 wherein the electrically conductive path comprises:
a first contact in the anterior portion proximate the hinge;
a conduit electrically connecting the printed circuit board to the first contact;
a second contact in the posterior portion proximate the hinge, the second contact electrically coupled to the core wire; and
a pin having an unfolded configuration and a folded configuration, wherein in the unfolded configuration, the pin electrically couples the first contact and the second contact and in the folded configuration, the pin isolates the first contact from the second contact.

13. The apparatus of claim 12 wherein the conduit is one of a coaxial cable and a shielded trace.

14. The apparatus of claim 12 wherein the pin comprises a first pin portion and a second pin portion, the first pin portion electrically coupled to the core wire and the second pin portion electrically coupled to the first pin portion, the second pin portion removably coupleable with the first contact.

15. The apparatus of claim 14 further comprising a housing surrounding at least the second pin portion, the housing received by the anterior portion of the first temple portion.

16. The apparatus of claim 1 wherein the core wire is deformable without breaking to retain at least the posterior portion in a shape.
